(19) United States
(12) Patent Application Publication
(10) Pub. No.: US 2006/0248447 A1
(43) Pub. Date: Nov. 2, 2006

(54) Indicating loading status of information from a computer network

(75) Inventor: Perttu Makkonen, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/119,835

(22) Filed: May 2, 2005

(51) Int. Cl. G06F 17/00

(52) U.S. Cl. 715/513

(57) ABSTRACT

Devices, methods and computer code products are disclosed displaying the download status of content to a device comprising changing the color of a display item such as a cursor based on the current download status. The cursor can be displayed a default color when no content is not currently being downloaded to the device, setting the cursor to a download indication color when content is currently being downloaded to the device, and setting the cursor to an error indication color when an error occurs while downloading content to the device.

### FIELD OF THE INVENTION

The present invention relates generally to information retrieval in a computer network. More specifically, the present invention relates to methods, systems, devices and computer program products for indicating the download status of information being retrieved in a computer network.

### BACKGROUND INFORMATION

As is known, the Internet is a network of computers, servers, and telecommunication networks that transmit messages in a digital form. The messages transmitted over the Internet can include Internet resources, such as hypermedia pages. Hypermedia pages, which can take many forms such as HyperText Markup Language (HTML) documents, Adobe Acrobat™ PDF files, video clips, digital photographs, etc., can be transferred as files from one server to another and finally to a receiving terminal. The HyperText Transfer Protocol (HTTP) is commonly used for data transmission on the Internet, however other protocols, such as File Transfer Protocol (FTP), or other network or wireless data transfer protocols could be used. The protocol typically transmits the information in the form of packets between terminals on the Internet.

Information and communication systems can be configured for accessing hypermedia pages and other information and content available on the Internet. These systems typically include a browser application, usually implemented in software, which can be used to select and download Internet content into the local memory of an end user device so that the content can be viewed or otherwise used by an end user.

Conventional information and communication systems typically include graphical user interfaces (GUIs). GUIs can include a display device and a user input device. The display device can present a series of icons or menus which a user selects or manipulates with the user input device to provide user input. Conventional user input devices can include cursor based pointing devices, such as a computer mouse, trackball, joystick, or the like. A pointing device can control movement and operation of the graphical cursor. For example, in some systems the pointing device can be used to manipulate the cursor over the icons or menu items displayed on the display device. The user can select an icon or menu item by positioning the pointer over the input area associated with the icon or menu item and clicking a select key.

The spread of electronics in everyday life has lead to the creation of smaller and smaller electronic devices with increasing interconnectivity with other electronic devices. These devices can include wireless communication devices, for example mobile telephones, alphanumeric pagers, “palmtop” computers, personal digital assistants (PDAs), and other small form factor, primarily handheld communication and computing devices. Many electronic devices now support not only basic point-to- point communication finctions like telephone calling, but also more advanced communications fimctions, such as electronic mail, facsimile receipt and transmission, Internet access and browsing of the World Wide Web including both uploading and downloading of information and the like. Generally, such wireless communication devices have software that is capable of managing the multitude of various handset finctions and the telecommunications connections. In other word, these small form factor wireless communication devices can include many functions and features previously available in larger form factor communication and information systems.

Wireless communication devices have generally reached a very desirable and small form factor—the smaller size is more user friendly than the older bulkier devices allowing the user to easily carry the device. Despite their small form factor, users still demand that their wireless communication devices include many of the features and functions of larger, less mobile devices. Thus, the predominant area of improvement and often the area upon which marketplace success or failure depends lies in the device's feature set and especially in the ease of use of such features.

Much of the focus of small form factor electronic devices has involved increasing the interconnectivity between various devices especially with regard to the transfer of multimedia information. Another focus has been to standardize the user interfaces and capabilities of small form factor devices with those of “full-size” personal computers. However, wireless communication devices present a variety of more challenging design and implementation issues that do not arise with larger processor-based systems, such as notebook and desktop computers, which may also have similar telecommunication features. These design challenges include the design of the user interface, the customization of the devices for particular service operators, the integration of Internet and World Wide Web access with other communication functionality, and the software development process.

Underlying all of these design challenges are the restrictions placed upon a small form factor electronic device by the very nature of its small size. Unlike desktop and notebook computers, wireless communication devices require a relatively small screen display size. Thus, the design of a wireless communication device must provide access to essentially the same features desktop computer users have become accustomed to, such as electronic mail, facsimiles, and Web browsing, yet with only a fraction of the screen area for displaying the requisite text, images, icons, etc. The difficulties are particularly significant when handling Web based content, since conventional Web content, such as forms and web-based user input systems, assume the larger screen size of conventional desktop computers and often inherently require a large display space. Such forms are difficult to see and use on the small screen of a wireless communication device. In addition, wireless communication devices also can be configured to download applications, ring tones, wallpaper and other desktop images from a wireless communication or enterprise network.

Despite these restrictions and challenges, small form factor devices must operate in conjunction with the established framework of communications means, such as the Internet. The many standards governing the capturing, storage and transmission of multimedia data are widely accepted by manufactures of digital devices and are increasingly being incorporated into digital devices to allow for the viewing and sharing of multimedia data in multiple formats and versions. On the Internet, the hypertext markup language (HTML) and Synchronized Media Integration Language (SMIL) are common standards for representing multimedia content. HTML is a Standard Generalized Markup Language (SGML) based standard defined by the World Wide Web Consortium (W3C). HTML describes a Web page as a set of media objects, elements or resources, such as images, video, audio, and applications, together with a presentation structure.

A more recent version of HTML called EXtensible HyperText Markup Language (XHTML) is a functionally equivalent version of HTML that is based on EXtensible Markup Language (XML) rather than SGML. SMIL is an XML-based language for integrating different media resources such as images, video, audio, etc. into a single presentation. SMIL contains features that allow for referencing media resources and controlling their presentation including timing and layout. SMIL also includes features for linking to other presentations in order to create hypermedia presentations. SMIL is a composition language which does not define any representations for the media resources or objects used in a presentation. Instead, SMIL defines a set of tags that allow media objects or resources to be integrated together or composed into a single presentation. While some SMIL features exist in HTML, SMIL focuses on the spatial and temporal layout of media resources and provides greater control of interactivity than HTML.

In any event, regardless of its actual form, users have come to expect that content, such as Internet hypermedia pages or other network content, will be available even on small form factor devices. One problem encountered by users, regardless of device size, is that they often experience a significant delay when downloading content to the end user device. This can be exacerbated in mobile devices which typically have relatively low processing power when compared to larger desktop computers. Since Internet content is typically designed to use the entire display area of the end user device, it becomes difficult to show the status of the download process, especially for small form factor devices which have a limited display area. For example, the user may have difficulty determining if content is being downloaded, if the download is complete, or if an error has occurred during the download process.

Proposals have been made to display a download status icon or banner which can be used to indicate the status of a download process. For example, many browsers include a stationary icon, such as a flag or globe, that becomes animated during periods when content is being downloaded. Such icons may comprise a flag that is normally stationary but flutters or waves during content download. Typically, this icon is visible at all times, but is animated only when content is being downloaded. One problem with this approach is that the download status icon or banner occupies valuable display space even though it is only relevant when the device is downloading content.

U.S. Pat. No. 6,399,780 proposes another approach for displaying download status. This patent proposes making the download status icon or banner temporary. In other words, this patent proposes removing the download status icon or banner when the device is not downloading content. When the device is downloading content, this patent proposes displaying an animated icon or banner, such as the flag mentioned above, on the display over the content viewing area. However, this approach suffers from some of the same problems as prior approaches in that the temporary download status banner occupies valuable display space otherwise normally used to display the content being downloaded.

Accordingly, it is desirable to provide the user systems or methods that enables a user to easily determine the download status of a web page in a more efficient, easier, and less burdensome fashion and which do not obscure the content being downloaded or otherwise waste valuable display real estate.

### SUMMARY OF THE INVENTION

One embodiment of the invention relates to a method for displaying the download status of Internet content on a display screen having a cursor. The method can include determining whether Internet content is currently being downloaded to the device, setting the cursor to a default color indicating that Internet content is not currently being downloaded to the device if it is determined that Internet content is not currently being downloaded to the device, and setting the cursor to a download indication color indicating that Internet content is currently being downloaded to the device if it is determined that Internet content is currently being downloaded to the device. The method can also include determining if an error occurred while downloading Internet content to the device, and if it is determined that an error did occur, setting the cursor to an error indication color indicating that an error occurred while downloading Internet content to the device.

Another embodiment of the invention relates to a computer code product for displaying the download status of Internet content on a display screen having a cursor. The computer code product can include computer code configured to determine whether Internet content is currently being downloaded to the device; set the cursor to a default color indicating that Internet content is not currently being downloaded to the device if it is determined that Internet content is not currently being downloaded to the device, and set the cursor to a download indication color indicating that Internet content is currently being downloaded to the device if it is determined that Internet content is currently being downloaded to the device. The computer code product can also include computer code configured to determine if an error occurred while downloading Internet content to the device, and if it is determined that an error did occur, to set the cursor to an error indication color indicating that an error occurred while downloading Internet content to the device.

Still another embodiment of the invention relates to a device for displaying the download status of Internet content. The device can include a communication interface, a display screen, computer code, memory, and a processor. The can be configured to download Internet content. The display screen can be configured for displaying a cursor and for displaying downloaded Internet content. The memory can be configured for storing the computer code. The computer code can include program instructions. The processor can be configured for executing the program instruction. The program instructions can be configured to cause the device to determine whether Internet content is currently being downloaded to the device; to set the cursor to a default color indicating that Internet content is not currently being downloaded to the device if it is determined that Internet content is not currently being downloaded to the device; and to set the cursor to a download indication color indicating that Internet content is currently being downloaded to the device if it is determined that Internet content is currently being downloaded to the device. The program instructions can also be configured to determine if an error occurred while downloading Internet content to the device, and if it is determined that an error did occur, to set the cursor to an error indication color indicating that an error occurred while downloading Internet content to the device.

Other principal features and advantages of the invention will become apparent to those skilled in the art upon review of the following drawings, the detailed description, and the appended claims.

### BRIEF DESCRIPTION OF THE DRAWINGS

FIG. 1 is a perspective view illustrating one embodiment of a mobile electronic device.

FIG. 2 is a perspective view the mobile electronic device of FIG. 1 in the closed position..

FIG. 3 is graphical illustration of one embodiment of a display screen displaying content in accordance with the present invention.

FIG. 4 is graphical illustration of another embodiment of a display screen displaying content in accordance with the present invention.

FIG. 5 is graphical illustration of another embodiment of a display screen displaying content in accordance with the present invention.

FIG. 6 is graphical illustration of another embodiment of a display screen displaying content in accordance with the present invention.

FIG. 7 is graphical illustration of another embodiment of a display screen displaying content in accordance with the present invention.

FIG. 8 is a block diagram of one embodiment of the mobile electronic device shown in FIGS. 1 and/or 2.

FIG. 9 is a graphical illustration of another embodiment of a display screen displaying content in accordance with the present invention.

FIG. 10 is graphical illustration of another embodiment of a display screen displaying content in accordance with the present invention.

FIG. 11 is graphical illustration of another embodiment of a display screen displaying content in accordance with the present invention.

FIG. 12 is graphical illustration of another embodiment of a display screen displaying content in accordance with the present invention.

FIG. 13 is graphical illustration of another embodiment of a display screen displaying content in accordance with the present invention.

### DETAILED DESCRIPTION OF THE PREFERRED EMBODIMENTS

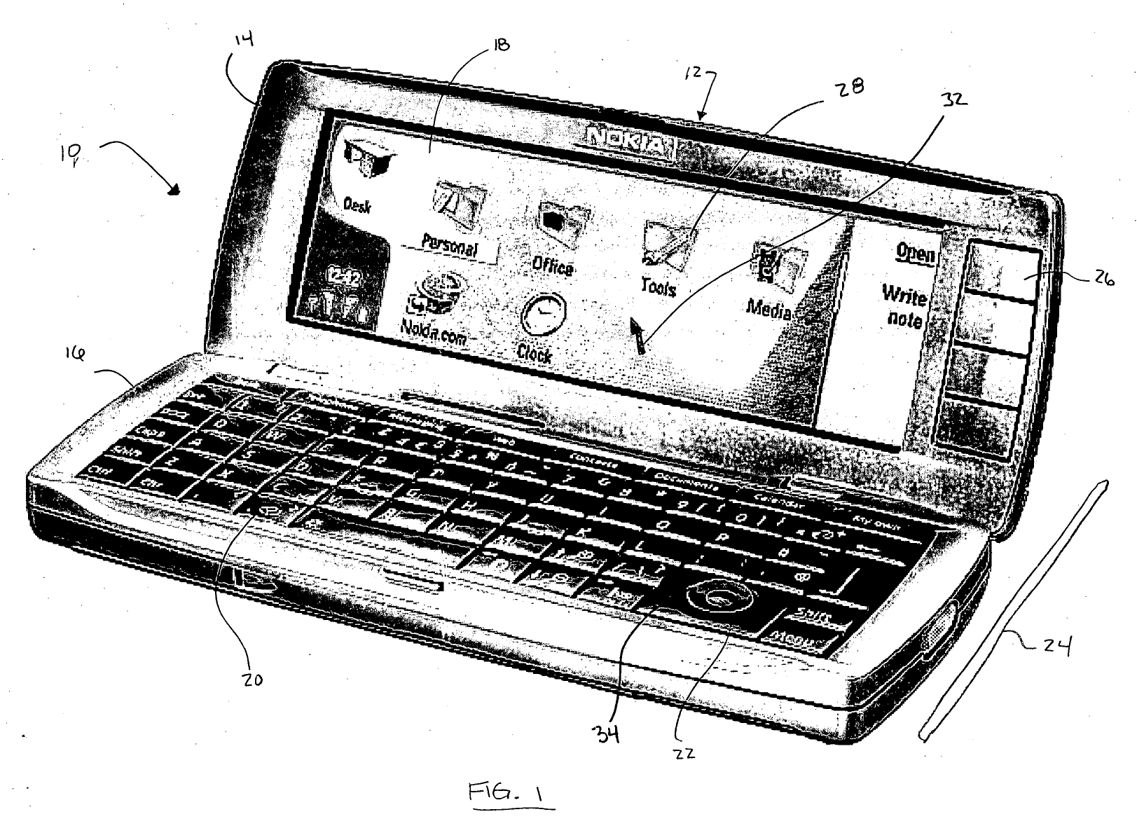

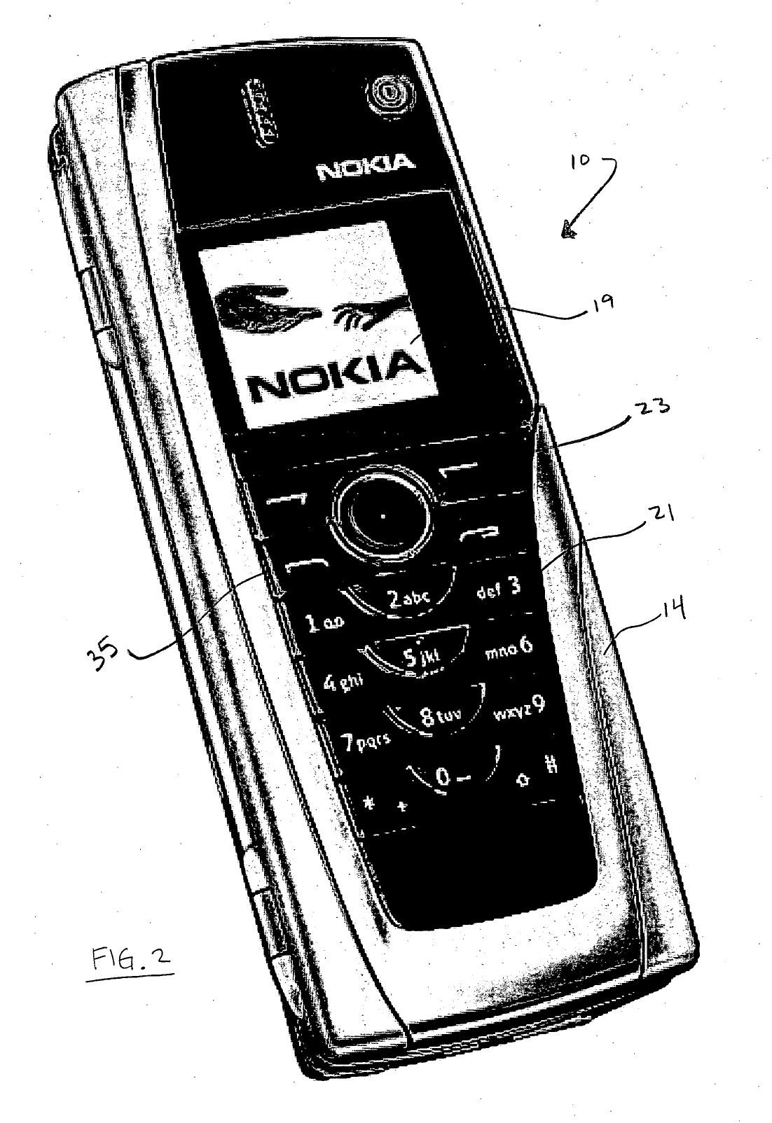

Referring to FIG. 1, one embodiment of a mobile electronic device is generally designated by reference numeral 10. The device 10, in this case, comprises a handheld computing device FIG. 2 illustrates another possible embodiment of the invention by describing the functionality of the device 10 of FIG. 1 in the closed position. In these embodiments, the device 10 comprises a mobile telephone, however the invention can also be applied equally well to other types of mobile electronic devices or other non-mobile devices having a display.

As shown in FIG. 1, the device 10 can include a casing 12 having a cover 14 and a base 16. A display screen 18 can be mounted inside the cover 14 and hinged to the base 16 to pivot between an open position, which exposes the display screen 18, and a closed position, which protects the display screen 18. The device 10 can be equipped with a variety of input devices such as a keyboard 20, a trackball pointing device 22, and select keys 34. In addition, the display screen 18 can comprise a touch screen and a stylus 24 can be included for activating the touch screen feature of the display screen 18. Additional “soft keys” 26 can also be included for selecting context sensitive features displayed on the display screen 18.

FIG. 2 illustrates the device 10 of FIG. 1 in the closed position. As can be seen, a second display screen 19 can be mounted on the outside of the cover 14. Additional input devices, such as a keypad 21, a second trackball pointing device 23, and additional select keys 35, can be included on the outside of the cover 14.

Other exemplary electronic devices may include, but are not limited to, a PDA, an integrated messaging device (IMD), a desktop computer, and a notebook computer. The electronic devices may be stationary or mobile as when carried by an individual who is moving. The electronic devices may also be located in a mode of transportation including, but not limited to, an automobile, a truck, a taxi, a bus, a boat, an airplane, a bicycle, a motorcycle, etc. Some or all of the electronic devices may send and receive calls and messages and communicate with service providers through a wireless connection to a base station. The base station may be connected to a network server that allows communication between the mobile telephone network and the Internet. The system may include additional electronic devices and communication devices of different types.

The communication devices may communicate using various messaging or bearer technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

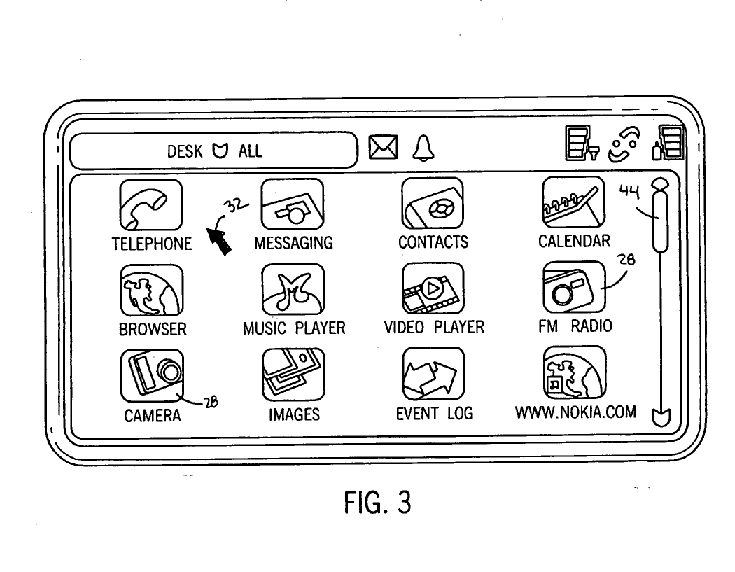

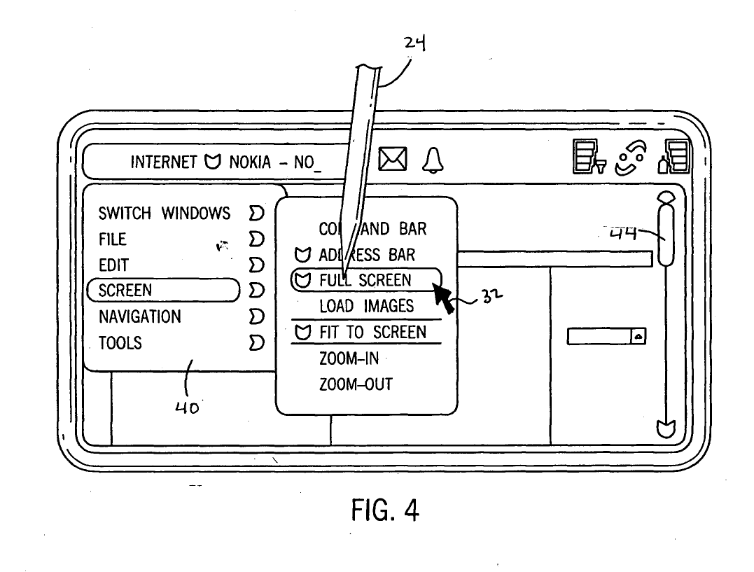

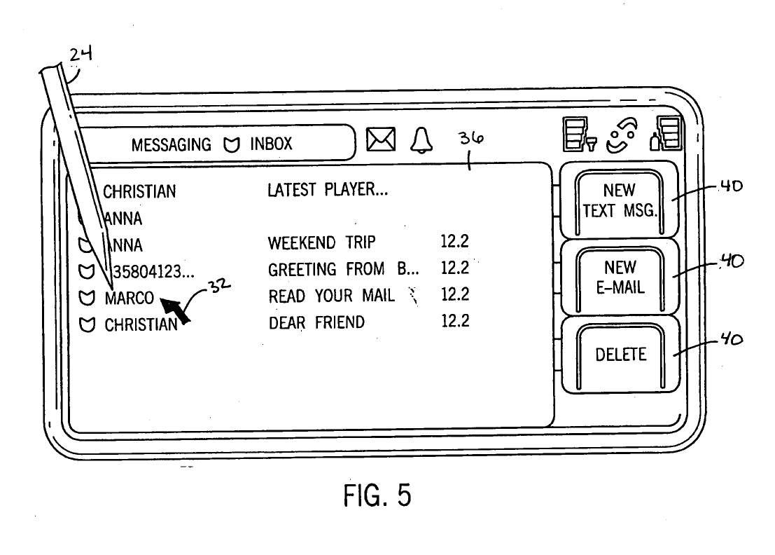

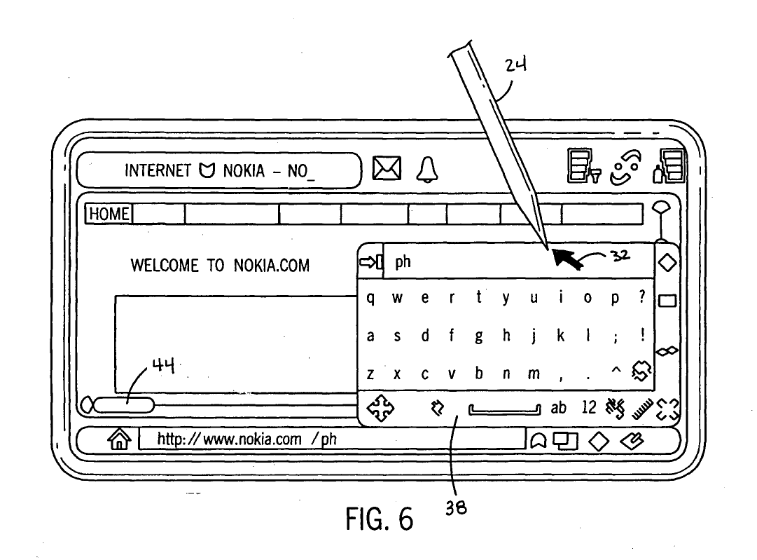

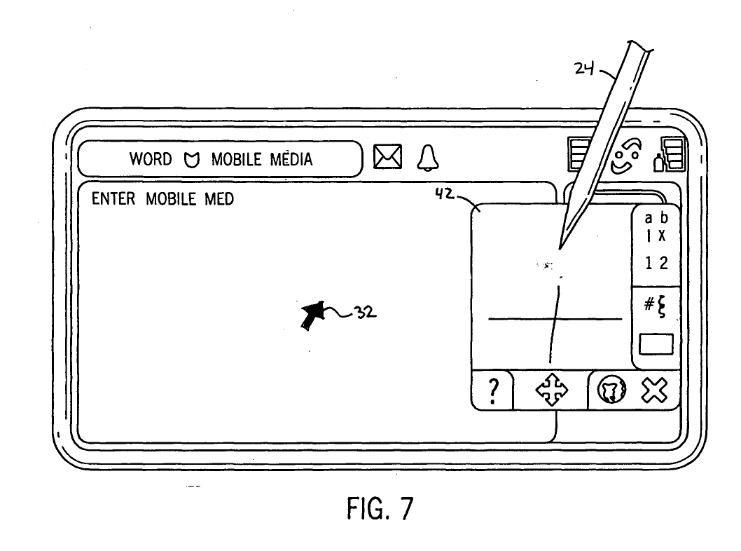

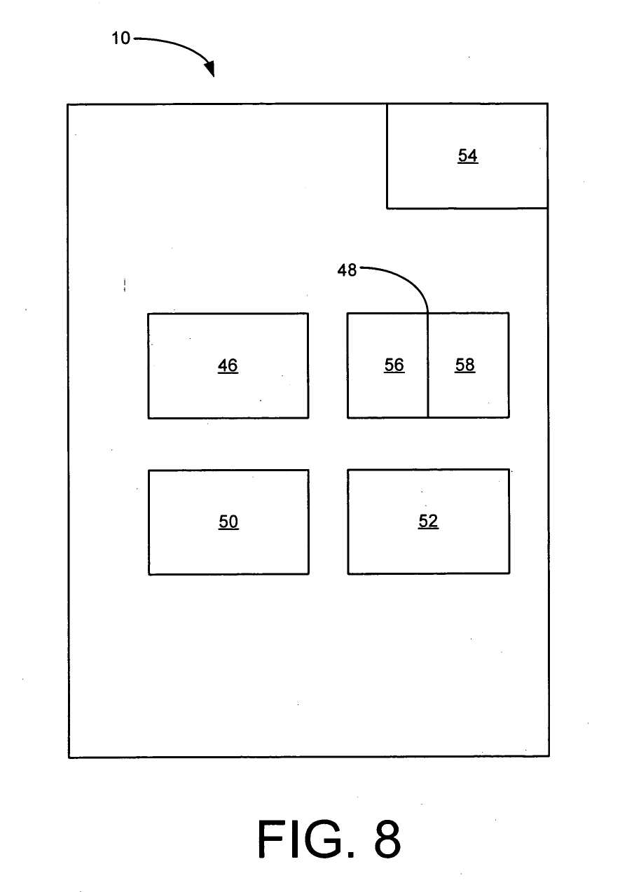

As can be seen in FIGS. 1-7, icons 28 (see also FIG. 4), menus 30 (see FIG. 5), lists 36 (see FIG. 6), a virtual keyboard 38 (see FIG. 7), response buttons 40 (see FIG. 6), and/or a handwriting recognition input area 42 (see FIG. 8), as well as various display control tools such as scroll bars 44, etc. and other graphical and non-graphical elements can be displayed on the display screen 18 and/or second display screen 19. A cursor 32, which can be manipulated by the pointing device 22, can also be displayed on the screen 18. As mentioned above, the pointing device 22 or second pointing device 23 can be used to move the cursor 32 over an icon 28, menu 30 item, etc. and the user can select the icon 28 or menu 30 item by clicking a select key 34 or 35. FIG. 8 illustrates one embodiment of the functional components of a mobile electronic device, such as, for example, the device 10 illustrated in FIGS. 1 and 2. The device 10, can comprise a processor 46, memory 48, an input interface 50, a display 52, and a communications unit 54. Different and additional components may be incorporated into the device 10.

The memory 48 can further comprise volatile memory 56, which can be used a working memory, and non-volatile memory 58, which can be used as storage memory. Computer code can be stored in the non-volatile memory 58 and loaded into volatile memory 56 upon activation of the device 10. The processor 46 can be configured to run the computer code to control operation of the device 10. The memory 48 may also store one or more applications The device 10 may have one or more memory 48 that uses the same or a different memory technology. Memory technologies include, but are not limited to, RAM, Read Only Memory (ROM), flash memory, XIP, etc.

The display 52 presents information to a user. The display 52 may be a thin film transistor (TFT) display, a light emitting diode (LED) display, a Liquid Crystal Display (LCD), a Cathode Ray Tube (CRT) display, or any of a variety of different displays known to those skilled in the art now or in the future.

The input interface 50 provides an interface for receiving information from the user for entry into the device 10. The input interface 50 may use various input technologies, such as those identified in FIGS. 1 and 2, including, but not limited to, a keyboard, a pen and touch screen, a mouse, a track ball, a touch screen, a keypad, one or more buttons, etc. to allow the user to enter information into the device 10 or to make selections. The input interface 50 may provide both an input and an output interface. For example, a touch screen both allows user input and presents output to the user.

The communications unit 54 can comprise a radio interface for enabling radio communications between multiple devices either directly or through a communications network. The communication interface 54 may provide an interface for receiving and transmitting calls, messages, files, and any other information communicable between devices. Communications between the device 10 and other devices may be through one or more of the following connection methods, without limitation: an infrared communications link, a radio frequency communication link, a wireless communications link, a cellular network link, a link established according to TCP/IP, etc. Transferring content to and from the device may be through one or more of these connection methods. The device 10 may communicate using various transmission technologies including, but not limited to, CDMA, GSM, UMTS, TDMA, TCP/IP, Bluetooth, IrDA, RFID, etc. The device 10 may communicate using various media including, but not limited to, radio, infrared, laser, optical, USB, Ethernet, IEEE 1394, etc.

The processor 46 executes instructions that cause the device 10 to behave in a predetermined manner. The instructions may be written using one or more programming language, scripting language, assembly language, etc. Additionally, the instructions may be carried out by a special purpose computer, logic circuits, or hardware circuits. Thus, the processor 46 may be implemented in hardware, firmware, software, or any combination of these methods. The term “execution” is the process of running a program or the carrying out of the operation called for by an instruction. The processor 46 executes an instruction, meaning that it performs the operations called for by that instruction. The processor 46 couples to the communication interface 54 to relay received information from another device to the one or more application, or to send information from the one or more applications to another device.

The processor 46 may retrieve a set of instructions from a permanent memory device and copy the instructions in an executable form to a temporary memory device. The temporary memory device is generally some form of RAM. The data in RAM is volatile meaning that it remains only as long as the device is turned on. When the device is turned off, RAM loses its data. ROM refers to special memory used to store programs that boot the device and perform diagnostics. The values stored in ROM are always there, whether the power is on or not. Flash memory is a type of constantly-powered nonvolatile memory that can be erased and reprogrammed in units of memory called blocks.

The computer code can include an operating system for controlling operation of the device 10, as well as application software for performing various specialized functions and providing various user services. The application is an organized set of instructions that, when executed, cause the device 10 to behave in a predetermined manner. One such application can include a browser for example configured for retrieving information and content from the Internet. Other applications may include, but is not limited to, a word processor application, a spreadsheet application, a presentation tool application, a video player/recorder application, an audio player/recorder application, an image editor/viewer application, a directory file system browser application, a messaging application such as an e-mail, an instant messaging application, or a facsimile application, a scheduling application, a contacts application, etc.

As is described above, current methods and systems for determining the download status of Internet content present particular problems for mobile or small screen size devices. Common methods of displaying download status require the use of valuable display space leaving an even smaller amount of screen space available for displaying the content being downloaded.

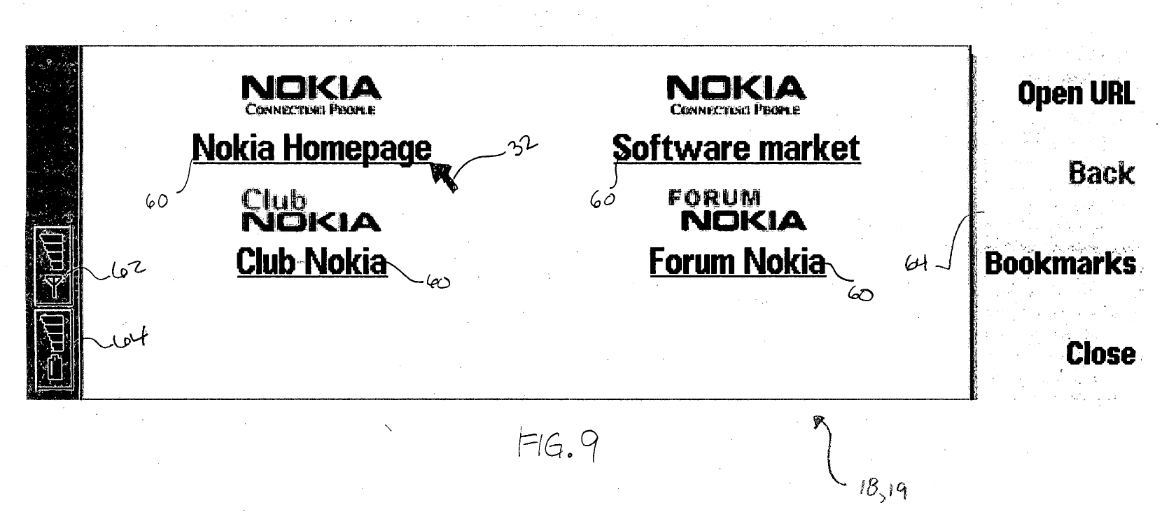

In one embodiment of the invention, such as the one shown in FIG. 9, existing display items, such as the cursor 32, can be used to display the download status of content. In this manner, no additional screen space is wasted on a download status indicator leaving as much space as possible for displaying the downloaded content. For example, the color of the cursor 32 can be changed to indicate download status. In one exemplary embodiment, the cursor color can be white when no download is being executed, green when a download is in process, and red if an error occurs during a download.

Other types of status indication can also be conveyed by embodiments of the invention. For example, if the device 10 is a wireless communication device capable of receiving different types of information via different communication methods, it is possible one method may take priority over another, thus temporarily “interrupting” the lower priority method. For example, if the user is in the process of downloading content using GPRS and the device receives a voice call or SMS message, the voice call or SMS message may take precedence over the GPRS session thus temporarily halting the download of content, via GPRS, during the duration of the voice call or SMS transmission. In this case, the cursor 32 color may be changed to yellow for example, indicating that content download has not been completed but is temporarily halted until completion of the higher priority transmission. This additional status indication can be used to differentiate from other error conditions, such as when the download is permanently interrupted by, for example, the user interaction (user pressing the escape key or other abort action, etc.) or loss of services . In another embodiment, various different colors can be used to signify different error conditions. For example, one color may be used to signify an abort action by the user and another can be used to signify error caused by loss of service, etc.

In one embodiment, the cursor 32 size can be adjusted. For example, the user can make the cursor 32 large when downloading in order to easily monitor download status. In this case, or even when the cursor 32 has not been enlarged, the cursor 32 can be moved to the comer of the display 52 and beyond the borders of the display 52 so that the user can view the content shown on the display 52. In some embodiments, the user may also be able to toggle the cursor 32 on and off. In other words, a command may be available which makes the cursor 32 invisible, allowing the user to vide the content shown on the display 52. Executing the command while the cursor 32 is invisible, will make the cursor 32 visible again, thus allowing the user to monitor download status.

As shown in FIG. 9, the cursor 32 can be manipulated to point to a hyperlink 60 which provides a “clickable” link to Internet content. A request to download the Internet content can be made by positioning the cursor 32 over the hyperlink 60 and “clicking” a select key 34, 35 (see FIGS. 1 and 2). In response to a request to download Internet content, the device 10 establishes a connection to the Internet and begins downloading the content. In this case the cursor 32 can change from its default color (for example white in the embodiment described above) to a color signifying download in progress (such as green in the embodiment described above) to signal to the user of the device that Internet content is in the process of being downloaded. If an error occurs during the download, the cursor 32 can change to a color signifying an error (such as red in the embodiment described above).

In another embodiment, the color change can be animated. For example, during download the color can fade from white to green back to white until the download is complete and/or the cursor can blink from red to white (and back) if an error has occurred during download. In one embodiment, different animation speeds can be used to signify different download speeds. Additional download status states can be added by incorporating different colors.

As described above, various other elements can be displayed on the display screen 18, 19. In addition to those described above with reference to FIGS. 1-7, status indicators, such as a signal strength indicator 62 for indicating the strength of a communication connection, or a battery indicator 64, or a specialized Internet browser menu 66, can be displayed on the display screen 18, 19.

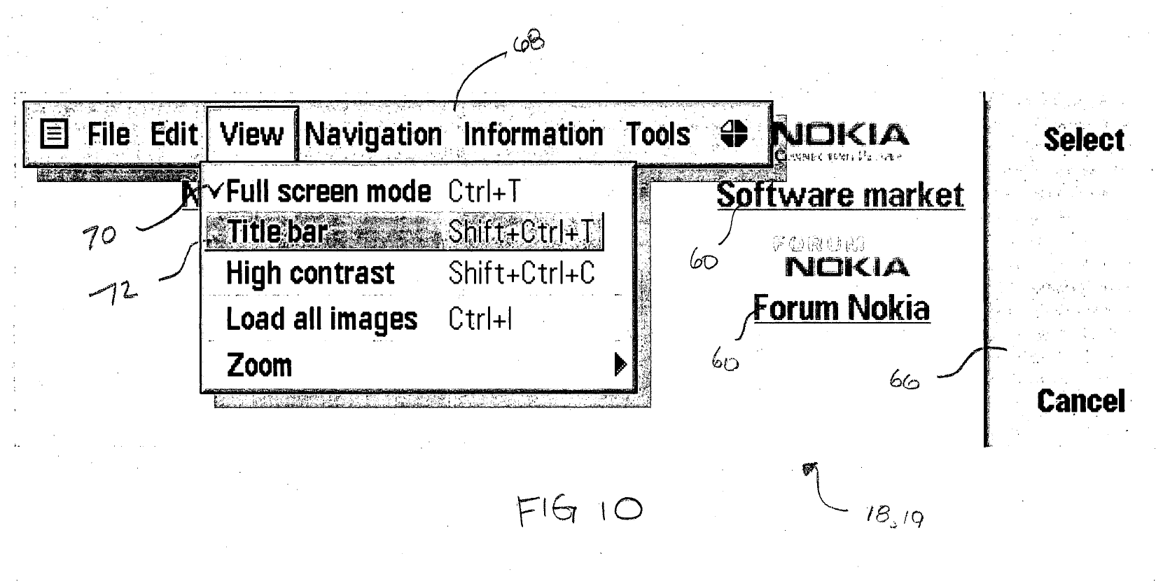

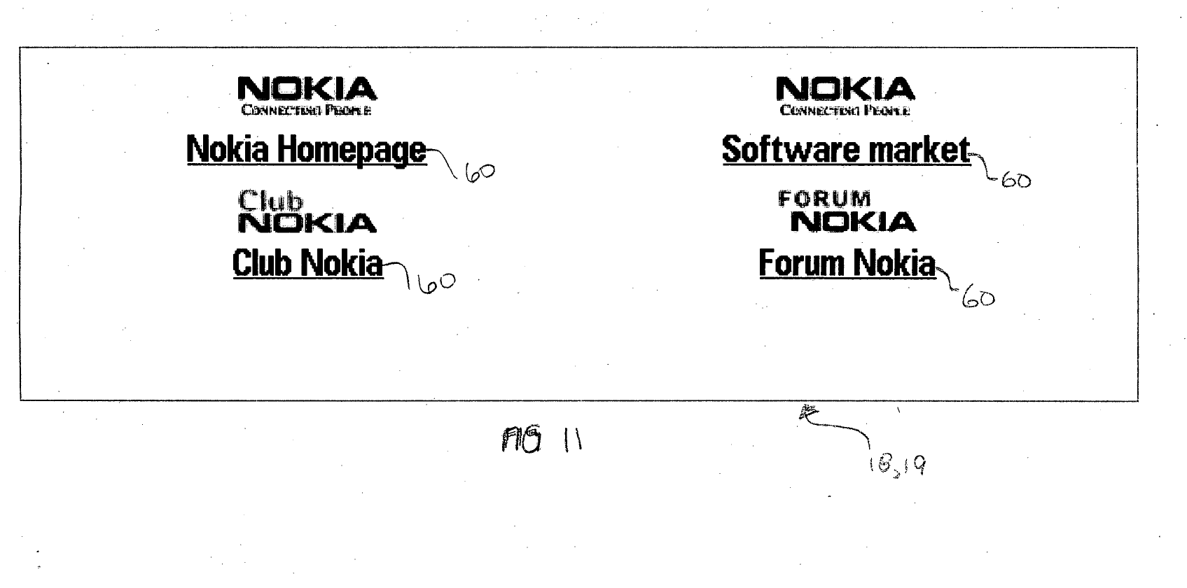

Temporary, removable menu bars 68, such as the one shown in FIG. 10, can be used to select between various screen display modes. For example, the user can use the menu bar 68 to select a full screen mode 70 in which the various display elements are hidden and the entire screen is used for displaying Internet content (as shown in FIG. 11 for example).

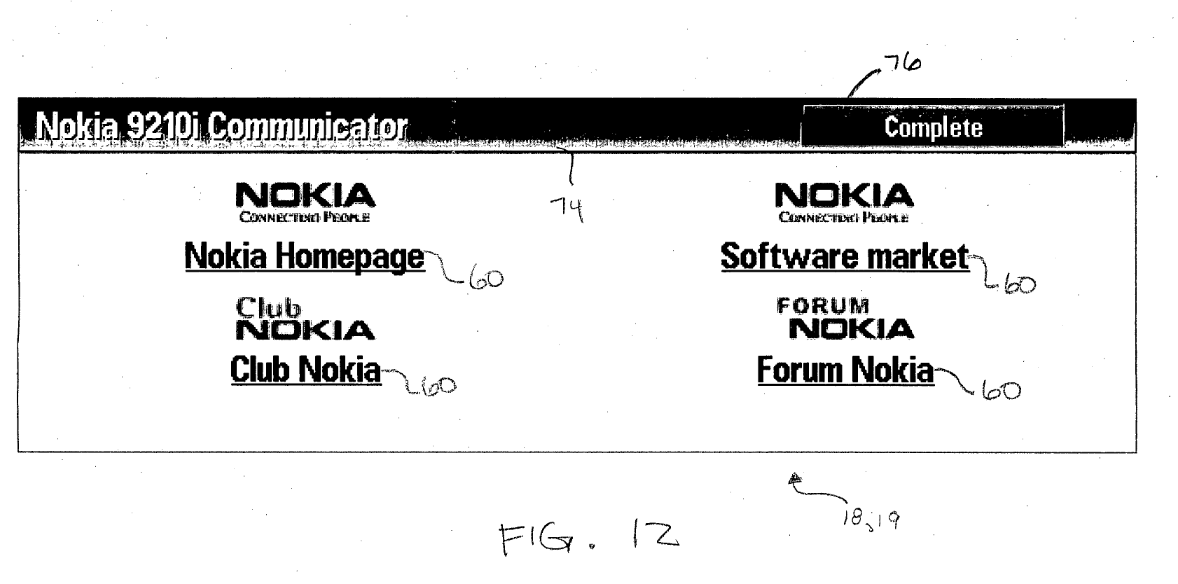

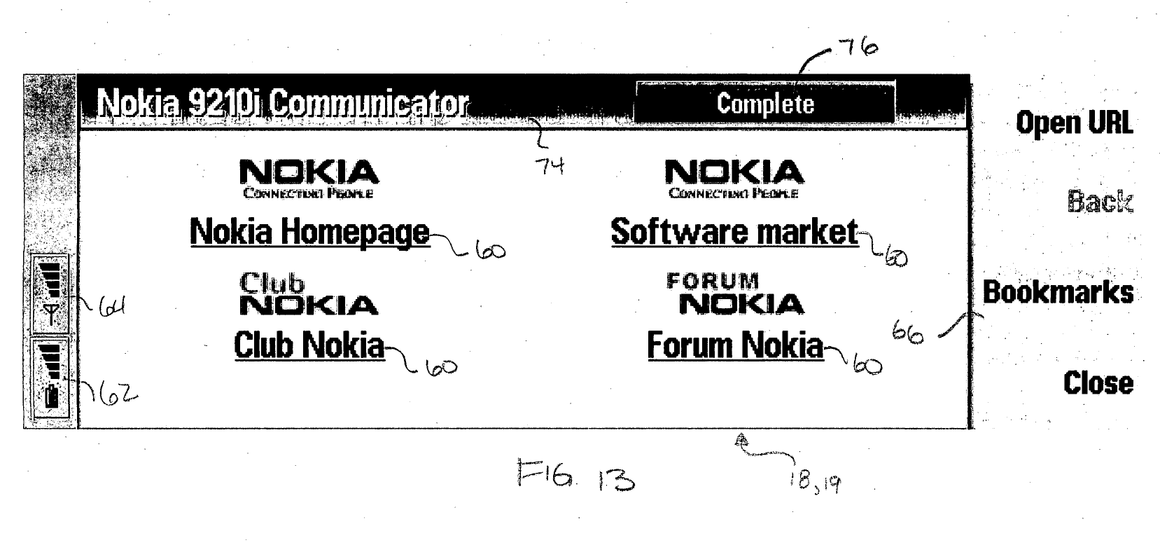

An optional, removable title bar 74 (see FIG. 12) can also be included by selecting the title bar option 72 on the menu bar 68. The title bar 74 can be used to display the name of the device 10. In addition, a download legend 76 (see FIG. 12) can be included in the title bar 74. Since the default color scheme of the cursor for indicating download status may not be intuitive to the user, the legend 76 can be used by the user until the user becomes accustomed to associating a certain cursor color with the download status of the device 10. Once the user has associated the cursor color scheme with its download status indication, the user can use the menu bar 68 to remove the title bar 74 gaining valuable display screen 18, 19 real estate in the process. The title bar 74 can be displayed in full screen mode (such as shown in FIG. 12) or when full screen mode is turned off (such as shown in FIG. 13). As such, the menu bar can be used by the user to customize the display screen 18, 19 to provide the maximum possible display screen 18, 19 real estate, while still providing the user with his or her preferred level of other menus, display items, and status indicators.

It should be understood that the invention is not confined to the particular embodiments set forth herein as illustrative, but embraces all such modifications, combinations, and permutations as come within the scope of the following claims. Thus, the description of the preferred embodiments is for purposes of illustration and not limitation.

What is claimed is:

1. An method for displaying the download status of content to a device with a display screen having a cursor, the method comprising:
determining whether content is currently being downloaded to the device; and
if it is determined that the content is not currently being downloaded to the device, setting the cursor to a default color indicating that content is not currently being downloaded to the device; or
if it is determined that content is currently being downloaded to the device, setting the cursor to a download indication color indicating that content is currently being downloaded to the device.

2. The method of claim 1, further comprising determining if an error occurred while downloading content to the device, and if it is determined that an error did occur, setting the cursor to an error indication color indicating that an error occurred while downloading content to the device.

3. The method of claim 1, further comprising determining if content download has been temporarily interrupted, and if it is determined that content download has been temporarily interrupted, setting the cursor to a temporarily interrupted indication color indication that the content download has been temporarily interrupted.

4. The method of claim 1, further comprising providing a removable download status legend indicator for associating the default color with a download status indicating that content is not currently being downloaded to the device and for associating the download indicator color with a download status indicating that content is currently being downloaded to the device.

5. The method of claim 4, further comprising determining if an error occurred while downloading content to the device, and if it is determined that an error did occur, setting the cursor to an error indication color indicating that an error occurred while downloading content to the device, and wherein the status legend indicator is further configured for associating the error indication color with a download status indicating that an error occurred while downloading content to the device.

6. The method of claim 1, further comprising animating the cursor when content is currently being downloaded to the device by causing the cursor to alternate between the download indication color and the default color.

7. The method of claim 2, further comprising animating the cursor when an error occurred while downloading content to the device by causing the cursor to blink between the error indication color and the default color.

8. A computer code product for displaying the download status of content to a device with a display screen having a cursor, the computer code product comprising:
computer code configured to
determine whether content is currently being downloaded to the device; and
if it is determined that content is not currently being downloaded to the device, set the cursor to a default color indicating that content is not currently being downloaded to the device; or
if it is determined that content is currently being downloaded to the device, set the cursor to a download indication color indicating that content is currently being downloaded to the device.

9. The computer code product of claim 8, further comprising computer code configured to determine if an error occurred while downloading content to the device, and if it is determined that an error did occur, to set the cursor to an error indication color indicating that an error occurred while downloading content to the device.

10. The computer code product of claim 8, further comprising computer code configured to determine if content download has been temporarily interrupted, and if it is determined that content download has been temporarily interrupted, setting the cursor to a temporarily interrupted indication color indication that the content download has been temporarily interrupted.

11. The computer code product of claim 8, further comprising computer code configured to provide a removable download status legend indicator for associating the default color with a download status indicating that content is not currently being downloaded to the device and for associating the download indicator color with a download status indicating that content is currently being downloaded to the device.

12. The computer code product of claim 11, further comprising computer code configured to determine if an error occurred while downloading content to the device, and if it is determined that an error did occur, to set the cursor to an error indication color indicating that an error occurred while downloading content to the device, and wherein the status legend indicator is further configured for associating the error indication color with a download status indicating that an error occurred while downloading content to the device.

13. The computer code product of claim 8 further comprising computer code configured to animate the cursor when content is currently being downloaded to the device by causing the cursor to alternate between the download indication color and the default color.

14. The computer code product of claim 9, further comprising computer code configured to animate the cursor when an error occurred while downloading content to the device by causing the cursor to blink between the error indication color and the default color.

15. A device for displaying the download status of content, the device comprising: a communication interface for downloading content;
a display screen for displaying a cursor and for displaying downloaded content;
computer code comprising program instructions;
memory for storing the computer code; and
a processor configured for executing the program instruction, the program instructions configured to cause the device to:
determine whether content is currently being downloaded to the device; and
if it is determined that content is not currently being downloaded to the device, to set the cursor to a default color indicating that content is not currently being downloaded to the device; or
if it is determined that content is currently being downloaded to the device, to set the cursor to a download indication color indicating that content is currently being downloaded to the device.

16. The device of claim 15, wherein the program instructions are further configured to determine if an error occurred while downloading content to the device, and if it is determined that an error did occur, to set the cursor to an error indication color indicating that an error occurred while downloading content to the device.

17. The device of claim 15, wherein the program instructions are further configured to determine if content download has been temporarily interrupted, and if it is determined that content download has been temporarily interrupted, setting the cursor to a temporarily interrupted indication color indication that the content download has been temporarily interrupted.

18. The device of claim 15, wherein the program instructions are further configured to provide a removable download status legend indicator on the display screen for associating the default color with a download status indicating that content is not currently being downloaded to the device and for associating the download indicator color with a download status indicating that content is currently being downloaded to the device.

19. The device of claim 18, wherein the program instructions are further configured to determine if an error occurred while downloading content to the device, and if it is determined that an error did occur, to set the cursor to an error indication color indicating that an error occurred while downloading content to the device, and wherein the status legend indicator is further configured for associating the error indication color with a download status indicating that an error occurred while downloading content to the device.

20. The device of claim 15 wherein the program instructions are further configured to animate the cursor when content is currently being downloaded to the device by causing the cursor to alternate between the download indication color and the default color.

21. The device of claim 16, wherein the program instruction are further configured to animate the cursor when an error occurred while downloading content to the device by causing the cursor to blink between the error indication color and the default color.
